(19) United States
(12) Patent Application Publication
(10) Pub. No.: US 2010/0250622 A1
(43) Pub. Date: Sep. 30, 2010

(54) METHOD OF AUTOMATICALLY GENERATING AN SSD FILE

(75) Inventor: Luc Hossenlop, Saint Jean de Vedas (FR)

Correspondence Address: Nixon Peabody LLP, P.O. Box 60610, Palo Alto, CA, 94306, US

(73) Assignee: Areva T & D Protection et Controle, Lattes (FR)

(21) Appl. No.: 12/739,675

(22) PCT Filed: Oct. 22, 2008
(86) PCT No.: PCT/EP08/64280

§ 371 Date: Apr. 23, 2010

(30) Foreign Application Priority Data
Oct. 23, 2007 (FR) 0758501

(51) Int. Cl. G06F 17/30

(52) U.S. Cl. 707/803; 707/E17.044

(57) ABSTRACT

The invention relates to a method of automatic generation of a system specification description (SSD) file from a diagram of an electrical installation, the diagram comprising conventional symbols representing the electrical elements of the said installation and attributes representing the specific electrical characteristics of each electrical element.

This method includes the following steps:
identifying the conventional symbols from an image of the said electrical diagram;
associating the identified type signals with known entities;
identifying, from the said image, the functional blocks, the graphic instances that represent each conventional symbol, the attributes associated with each conventional symbol, and the topology of the electrical connections of each conventional symbol;
associating a standard label with each identified conventional symbol;
generating a correspondence table containing each identified symbol and the corresponding standard label; and
storing in an SSD type file the said correspondence table and the electrical topology of the identified conventional symbols.

### CROSS REFERENCE TO RELATED APPLICATIONS OR PRIORITY CLAIM

This application is a national phase of International Application No. PCT/EP2008/064280, entitled, “Method Of Automatically Generating An SSD File”, which was filed on Oct. 22, 2008, and which claims priority of French Patent Application No. 07 58501, filed Oct. 23, 2007.

### TECHNICAL FIELD

This invention lies in the field of automating industrial operations, and relates more specifically to a method of automatically generating a system specification description (SSD) file from a diagram of an electrical installation (whether for control or power), the diagram comprising conventional symbols representing the electrical elements of the said installation and attributes representing the specific electrical characteristics of each electrical element.

The invention also relates to an apparatus that comprises means for performing the method of the invention, and a computer program stored in a memory and comprising logic modules for performing the method of the invention.

### CURRENT STATE OF THE PRIOR ART

The purpose of International Electrotechnical Commission (IEC) standard number 61850 is to standardize networks and communications systems so as to enable intelligent electronic devices (IED) made by different manufacturers to share control and protection functions. In addition, IEC standard 61850 offers resources for modeling the functions of a piece of equipment, by means of the concept of logical nodes that represent the smallest sub-function having formally defined inputs and/or outputs, and that are able to process data derived from other logical nodes. For this purpose, the logical nodes are modeled in classes consisting of objects of predefined databases. The exchanges between logical nodes are carried by means of sets of standard protocols.

The description of an installation can therefore be achieved by means of a standard syntax and presented in the form of a system specification description (SSD) corresponding to paper documents or computer files that represent the single-line diagram or functioning diagram for the electrical installation.

One problem in the prior art arises from the fact that SSD files are created manually, by defining the design functions and the topology of the piece of equipment concerned. This results in an increase, both in the cost of engineering control systems for items of electrical equipment, such as for substations, and in the time required for designing and testing the electrical installations.

One object of the invention is to automate the creation and proving of SSD files, starting with a graphic representation of the installation, this being typically a single-line diagram, so as to limit the cost and the time required for configuration and testing of electrical installations.

Another object of the invention is to provide systematic representation of items of electrical equipment, in SCL format, so as to facilitate factory testing and testing at the installation sites, and also to put in place an overall asset management system and to populate it from a common information model (CIM) database.

### SUMMARY OF THE INVENTION

The invention recommends a method of automatically generating a system specification description (SSD) file from a diagram of an electrical installation, the diagram comprising conventional symbols representing the electrical elements of the said installation and attributes representing the specific electrical characteristics of each electrical element.

According to the invention, the method includes the following steps:

identifying the conventional symbols from an image of the said electrical diagram;

associating the identified type signals with known entities;

identifying, from the said image, the functional blocks, the graphic instances that represent each conventional symbol, the attributes associated with each conventional symbol, and the topology of the electrical connections of each conventional symbol;

associating a standard label with each identified conventional symbol;

generating a correspondence table containing each identified symbol and the corresponding standard label; and

storing in an SSD type file the said correspondence table and the electrical topology of the identified conventional symbols.

In one particular embodiment of the invention, the said standard labels represent logical nodes and/or attributes of logical nodes as predefined in IEC standard 61850, and/or items of electrical connectivity information linking a conventional symbol to one or more other conventional symbols.

In a preferred version of the method of the invention, each conventional symbol and the topology of the corresponding electrical connections are identified by using a shape recognition method.

In another way of putting the method of the invention into practice, the method further includes a step that consists in taking the image of the electrical installation from a single-line diagram or from a computer assisted design (CAD) file.

According to a further feature of the invention, the method further includes a step that consists in associating at least one test sheet with each logic node.

### BRIEF DESCRIPTION OF THE DRAWINGS

Further features and advantages of the invention appear more clearly from the following description, which is given by way of non-limiting example and with reference to the accompanying drawings, in which:

FIG. 1 shows schematically one example of a single-line diagram for an electrical installation, from which an SSD file is generated by the method of the invention;

FIG. 2 is a schematic view of a sub-assembly from the image in FIG. 1;

FIG. 3 is a general, schematic, flowchart illustrating the essential steps in the method of the invention; and

FIG. 4 is a table of correspondence between conventional symbols and standard labels obtained by the method of the invention.

### DETAILED DESCRIPTION OF PARTICULAR EMBODIMENTS

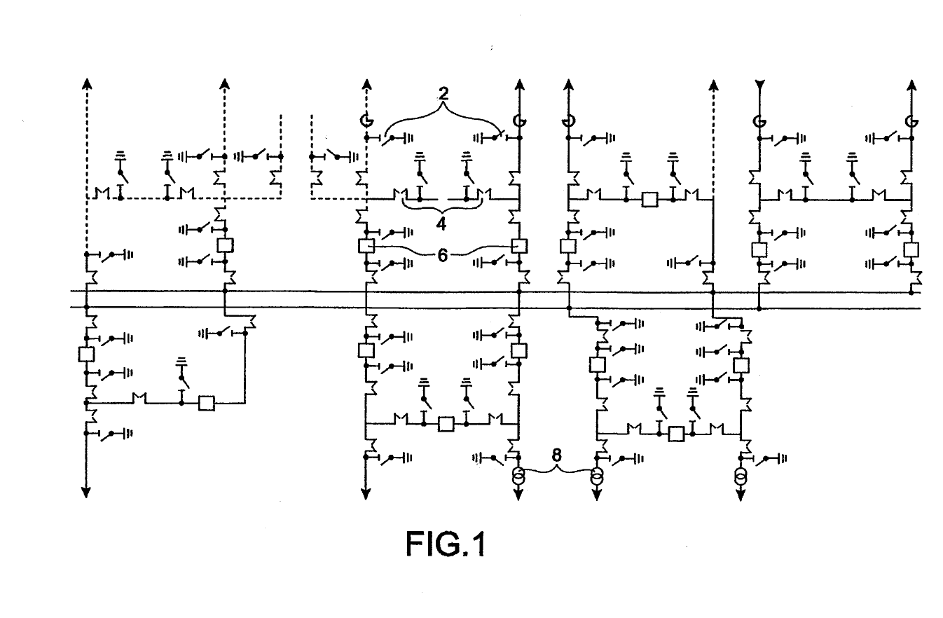

FIG. 1 is a diagram of an electrical installation, comprising a set of symbols for the electrical components of the said installation, such as earthing switch 2, line isolator 4, circuit breakers 6, and transformers 8.

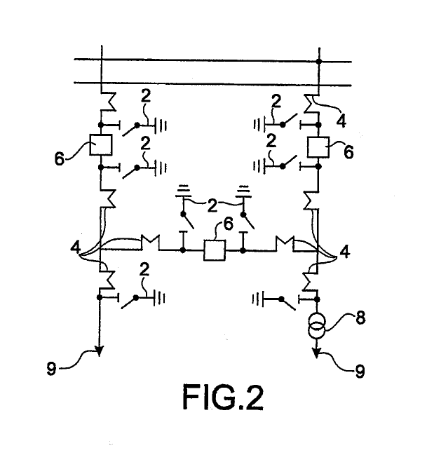

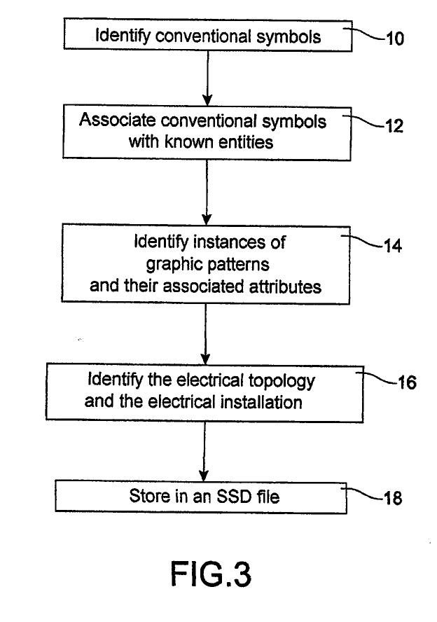

The essential steps in the method of the invention are described with reference to the diagram of FIG. 2 and the flowchart of FIG. 3. FIG. 2 is a detailed view taken from part of FIG. 1, and in which the graphic instances representing each conventional symbol, together with the attributes associated with each conventional symbol, are to be identified.

### Step 10: Identification of the Conventional Symbols (Patterns)

In this step, the symbols and their attributes are identified from the image consisting of FIG. 2 by a method of shape recognition, using an apparatus which, for example, comprises an image sensing device, a photographic apparatus, or an image analyzer module.

The conventional symbols are recognized in their various orientations (vertically or horizontally), and optionally in their various colors. More generally, other symbols can be recognized, in particular “I>” conventional symbols that represent protection elements.

The symbols are recognized by comparison of the sensed images with symbols that are contained in a predefined library. It is known that the method of recognition of symbols used consists of establishing a set of graphs, that is to say, a list of adjacent lines, by extracting contours of symbols captured. In the event that a sensed symbol is not present in the said library, an operator indicates the type of the symbol manually to the image analyzer module.

The informations created are made available to the image analyzer module in the form of a list that is exploited in the next step.

Step 12: Association of the Conventional Symbols with Known Entities

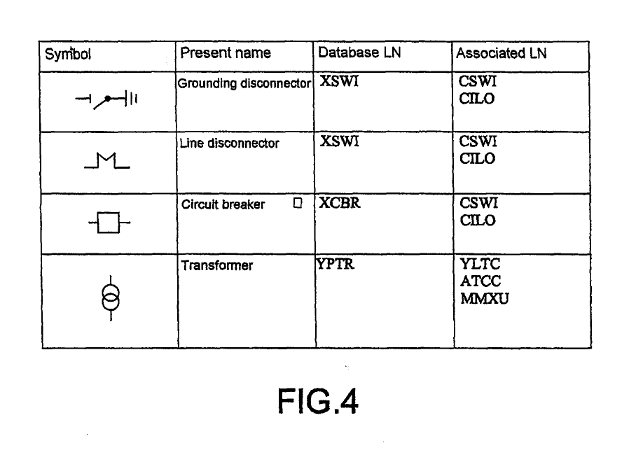

FIG. 2 shows symbols representing, respectively, an earthing switch 2, a line isolator 4, a circuit breaker 6, and a transformer 8. The names of these symbols, in current language, are associated with a logical node terminology in the context of IEC standard 61850. They are optionally associated with logical control or measurement nodes. For the various symbols of the image of FIG. 2, the result of this step, which is illustrated by the table in FIG. 4, in which the earthing switch 2 and the line isolator 4 are associated with the term XSWI that represents a basic logical node, the circuit breaker 6 is associated with the term XCBR, and the transformer 8 with the term YPTR.

In FIG. 4, the basic logical node (LN) corresponds to the functional element shown directly in the graphic diagram, and the associated LN corresponds to the function that is intimately associated with that element.

It should be noted that the association of each symbol with its standard representation is obtained automatically if the standard representation has been stored beforehand in a library. If not, the symbol will be identified manually by an operator.

Step 14: Identification of the Instances of Graphic Patterns and of Attributes Associated with them

The image shown in FIG. 2 contains eight instances of line isolators 2, eight instances of earthing switches 4, three instances of circuit breakers 6, and only one instance of a transformer 8.

The following attributes of the transformer 8 are characterized by means of the description of the attributes of the logical nodes which is defined in IEC standard 61850-7-4, as follows:

| EE Name | IBT#1 |
|---|---|
| HiVRtg | 400 |
| LoVRtg | 132 |
| PwrRTg | 200 |

The same is true for the attributes of the other instances.

This step also enables the geographical coordinates (the x,y coordinates) of the instances to be detected, so that the SSD file can be completed using the explanatory Annexe C of document IEC 61850-6, or using some similar syntax.

In this step, the image is traversed from top to bottom and from right to left, for example, to identify each graphical pattern, a graphical pattern is associated with one or more text elements. The text elements are detected by traditional methods of image recognition. The association between elements of text and graphical models is obtained by considering the minimum distance between an element of text and graphic elements. The association between elements of text and data structures IEC 61850 depends on each structure. For example, the fields PwRTg is associated with the foregoing indication VA or KVA.

The information thus created is used in the next step in the form of an XML schema.

### Step 16: Identification of the Electrical Topology

The electrical topology of the installation illustrated by FIG. 2 is identified by a shape recognition method, on the basis of the following principles already programmed in the image analyzer device:

a line joining a conventional symbol with another conventional symbol indicates electrical connectivity;

a set of busbars interconnecting a group of symbols consists of one or more lines; and

text including the term kV (for kilovolts) defines a voltage level associated with a group of components connected electrically together.

Thus, from FIG. 2, this method can detect that the circuit breaker 4-I452 is connected to the line isolators 4-I489A and 4-I489B. The electrical topology is projected into the IEC 61850 data model in the following way:

the number of connections is two for the circuit breaker 4-I452 and for each of the line isolators 4-I489A and 4-I489B; and

two connectivity nodes are created by the circuit breaker 4-I452, one of which is common to a connectivity node of the disconnector 4-I489A, while the other is common to a connectivity node of the disconnector 4-I489B.

More generally, a connectivity node may either:

be shared with a connection of another symbol, as in the example of the circuit breaker 4-I452 in FIG. 2; or

be isolated and without a link to the interior of the installation (this is illustrated by the two arrows 9 in FIG. 2, which show the connection of a line or cable to another electrical installation); or

be connected to a set of busbars connected to a group of connectivity nodes, but without including any symbols such as those shown in FIG. 1, in which the set of busbars corresponds to a voltage level of 400 kV.

### Identification of Blocks

Identification of the blocks is an important step in the IEC 61850 definition of the installation. The interpretation of the blocks in IEC 61850 may differ as between one user and another, depending on their ways of working. The method of the invention makes possible, automatically to identify blocks that consist of different functional parts, and the connection between symbols. The user can, if so desired, modify the proposed groupings.

The principle of this automatic identification consists in:

grouping together in a common block all of the symbols that connect together various sets of busbars, where there are in fact a plurality of busbars in the installation. All of the symbols may have a connection to a single connectivity node, as is shown for example in FIG. 2. If one of the symbols is of the “transformer” type, then the set of symbols is subdivided into two groups, on either side of the transformer, with each group constituting one block and the transformer being attributed to one of these groups; and

grouping together in a single block all of the symbols that connect together a single busbar line and a single connectivity node, in particular (though not only) when the installation has only one busbar line.

### Step 18: Creation of SSD File

An XML file of the SSD type is created from all of the products of Steps 12 and 14, and optionally that of Step 16.

This file comprises:

the description of the “substation” defined by the standard; and

optional extensions containing the representation of the symbols and their positioning.

The SSD type XML file so created is stored in Step 18, and is used in particular to configure a control system and to verify that the wiring of the electrical installation conforms with the electrical or functional diagram for the said installation.

The method of the invention can with advantage be used in the renewal of a control system in which the data files that describe the “single-line” diagram are not available, or are in a format that has become obsolete.

1. A method of automatically generating a system specification description (SSD) file from a diagram of an electrical installation, the diagram comprising conventional symbols representing the electrical elements of the said installation and attributes representing the specific electrical characteristics of each electrical element, the method being characterized by the following steps:
identifying (10) the conventional symbols from an image of the said electrical diagram;
associating (12) the identified type signals with known entities;
identifying (14, 16), from the said image, the functional blocks, the graphic instances that represent each conventional symbol, the attributes associated with each conventional symbol, and the topology of the electrical connections of each conventional symbol;
associating a standard label with each identified conventional symbol;
generating a correspondence table containing each identified symbol and the corresponding standard label; and
storing (18) in an SSD type file the said correspondence table and the electrical topology of the identified conventional symbols.

2. A method according to claim 1, wherein the said standard labels represent logical nodes and/or attributes of logical nodes as predefined in IEC standard 61850, and/or items of electrical connectivity information linking a conventional symbol to one or more other conventional symbols.

3. A method according to claim 1, wherein each conventional symbol and the topology of the corresponding electrical connections are identified by using a shape recognition method.

4. A method according to claim 2, further including a step that consists in associating at least one test sheet with each logic node.

5. A method according to claim 1, further including a step that consists in taking the image of the electrical installation from a single-line diagram or from a CAD file.

6. A method according to claim 1, wherein the said conventional symbols are identified from a library of predefined symbols.

7. A method according to claim 6, including a confirmation of the conventional symbols not identified in the library of predefined symbols.

8. A method according to claim 4, wherein the said tests consist in verifying the conformity of the cabling of the electrical installation with the electrical or functional diagram of the said installation.

9. Apparatus for automatically generating a system specification description (SSD) file from a diagram of an electrical installation, the diagram comprising conventional symbols representing the electrical elements of the said installation and attributes representing the specific electrical characteristics of each electrical element, the apparatus being characterized in that it comprises:
means for identifying the conventional symbols from an image of the said electrical diagram;
means for associating the identified type signals with known entities;
means for identifying, from the said image, the functional blocks, the graphic instances that represent each conventional symbol, the attributes associated with each conventional symbol, and the topology of the electrical connections of each conventional symbol;
means for associating a standard label with each identified conventional symbol;
means for generating a correspondence table containing each identified symbol and the corresponding standard label; and
means for storing in an SSD type file the said correspondence table and the electrical topology of the identified conventional symbols.

10. Apparatus according to claim 9, characterized in that it includes a shape recognition module for identifying each conventional symbol and the topology of the electrical connections corresponding to each conventional symbol.

11. A computer program stored in a memory and adapted to generate automatically a system specification description (SSD) file from a diagram of an electrical installation, the diagram comprising conventional symbols representing the electrical elements of the said installation and attributes representing the specific electrical characteristics of each electrical element, the apparatus being characterized in that it comprises:
a module for identifying the conventional symbols from an image of the said electrical diagram;
a module for associating the identified type signals with known entities;
a module for identifying, from the said image, the functional blocks, the graphic instances that represent each conventional symbol, the attributes associated with each conventional symbol, and the topology of the electrical connections of each conventional symbol;
a module for associating a standard label with each identified conventional symbol;
a module for generating a correspondence table containing each identified symbol and the corresponding standard label; and
a module for storing in an SSD type file the said correspondence table and the electrical topology of the identified conventional symbols.
